(19) United States
(12) Patent Application Publication
(10) Pub. No.: US 2012/0323762 A1
(43) Pub. Date: Dec. 20, 2012

(54) System and Method of Multi-Factor Balance Inquiry and Electronic Funds Transfer

(76) Inventors: Shashi Kapur, Fort Lauderdale, FL (US); Gary Palmer, Fort Lauderdale, FL (US); Ralph A. Bianco, Lagrangeville, NY (US); Terry Dooley, West Des Moines, IA (US); Eric Means, Des Moines, IA (US)

(21) Appl. No.: 13/159,936

(22) Filed: Jun. 14, 2011

(51) Int. Cl. G06Q 40/00

(52) U.S. Cl. 705/39; 705/35

(57) ABSTRACT

A system and method of processing balance inquiries and electronic funds transfers (EFTs) using multi-factor authentication. The method may include receiving an identifier of a financial account and contact information associated with the financial account and initiating a communication via the contact information. Upon receiving an authentication via the communication, the method may include processing a balance inquiry and/or EFT of the financial account based on the identifier and the authentication. The method may include determining a balance of the financial account based on the balance inquiry and/or causing funds to be electronically transferred. The system and method may also facilitate a balance inquiry from a mobile device to an EFT provider.

### FIELD OF THE INVENTION

The disclosure relates to automated balance inquiries and/or electronic funds transfers (“EFTs”), which may include withdrawing funds from or depositing funds into a bank account, and in particular to secure balance inquiries and/or EFTs using multi-factor authentication as well as processing balance inquiries and/or EFTs using mobile and other devices via EFT providers.

### BACKGROUND OF THE INVENTION

Mobile devices can be used for an increasing number of tasks such as using an Internet-connected phone for online banking. However, conventional systems fail to provide an ability to conveniently or securely determine a balance of a financial account or request an Electronic Funds Transfer (“EFT”) using mobile and other devices.

For instance, in order to determine a balance of a financial account (e.g., a checking account, etc.), a user typically must locate and use an Automated Teller Machine (“ATM”), call the bank, send a fax to a bank, or logon to a website of the bank. In order to process an EFT, a user typically must go to the bank or retailer that provides such services.

Thus, conventional systems have several drawbacks. For example, it can be inconvenient to locate an ATM or contact a bank. Furthermore, logging on to a web site or calling the bank can be a slow process, particularly for a retailer such as a casino calling on behalf of a customer to determine a balance of the financial account. Additionally, the bank may be closed at the time and the customer may to have to wait many hours or days for the transaction to complete.

Additionally, conventional systems can pose security risks. For example, authentication information such as a password or PIN entry can be intercepted or otherwise compromised when logging on to a website.

Thus, what is needed are systems and methods for efficient and real-time balance inquiries and/or EFTs from EFT providers. What is further needed are mobile device based readers and other readers that can leverage efficient and real-time balance inquiries and/or EFTs so that a user may easily request balance inquiries and EFTs. What is further needed are balance inquiries and/or EFTs with enhanced security. These and other problems exist.

### SUMMARY OF THE INVENTION

Various systems, computer program products, and methods for processing balance inquiries and/or EFTs are provided. According to various implementations of the invention, a method of processing a balance inquiry may include receiving an identifier of a financial account and contact information associated with the financial account. In some implementations of the invention, the method may include initiating a communication via the contact information. In some implementations of the invention, the method may include receiving an authentication via the communication, wherein the authentication authorizes access to the financial account. In some implementations of the invention, the method may include processing a balance inquiry of the financial account based on the identifier and the authentication. In some implementations of the invention, the method may include determining a balance of the financial account based on the balance inquiry.

According to various implementations of the invention, a method of processing an EFT may include receiving an identifier of a financial account, an indication of an amount of funds to be transferred, and contact information associated with the financial account. In some implementations of the invention, the method may include initiating a communication based on the contact information. In some implementations of the invention, the method may include receiving an authentication via the communication, wherein the authentication authorizes access to the financial account. In some implementations of the invention, the method may include communicating an EFT request associated with the financial account based on the identifier, the authentication, and the amount of funds to be transferred. In some implementations of the invention, the method may include causing the amount of funds to be transferred based on the EFT request.

According to various implementations of the invention, a method of processing balance inquiries from a mobile device to an EFT provider may include receiving an identifier of a financial account. In some implementations of the invention, the method may include communicating to a payment network a balance inquiry of the financial account based on the identifier. In some implementations of the invention, the method may include determining a balance of the financial account based on the balance inquiry.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system of processing balance inquiries and/or EFTs, according to various implementations of the invention.

FIGS. 2A, 2B, 2C, and 2D are block diagrams illustrating exemplary mobile devices, according to various implementations of the invention.

FIGS. 3A, 3B, and 3C are block diagrams illustrating exemplary POS readers, according to various implementations of the invention.

FIGS. 4, 5, 6, 7, 8, and 9 are screenshots illustrating exemplary interfaces of a mobile application operating at mobile device during different processing operations, according to various implementations of the invention.

FIG. 10 is a flow diagram illustrating an exemplary process of multi-factor balance inquiries, according to various implementations of the invention.

FIG. 11 is a flow diagram illustrating an exemplary process of multi-factor EFTs, according to various implementations of the invention.

FIG. 12 is a flow diagram illustrating an exemplary process of balance inquiries from EFT providers using mobile devices, according to various implementations of the invention.

### DETAILED DESCRIPTION OF THE INVENTION

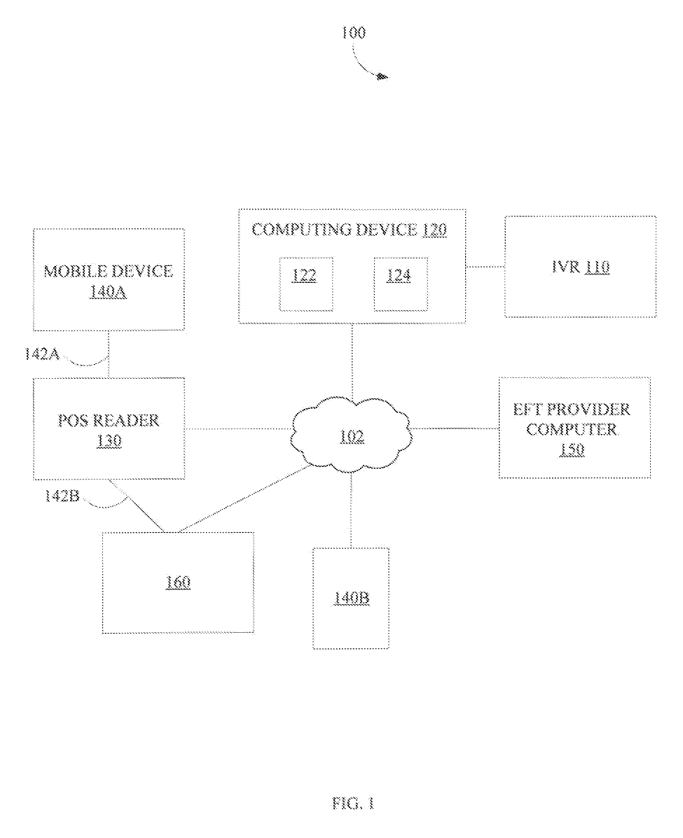

FIG. 1 is a block diagram illustrating a system 100 for processing balance inquiries and/or electronic funds transfers (“EFTs”), according to various implementations of the invention. According to various implementations of the invention, system 100 may include, but is not limited to, an IVR subsystem 110 (hereinafter, “IVR 110”), a computing device 120, a point-of-sale (“POS”) reader 130, mobile devices (illustrated in FIG. 1 as mobile devices 140A, 140B), an EFT provider computer 150, and a client device 160. In some implementations of the invention, IVR 110, computing device 120, POS reader 130, mobile device 140, EFT provider computer 150, and client device 160 may be communicably coupled to one another via a network 102. Network 102 may include a Local Area Network, a Wide Area Network, a cellular communications network, a Public Switched Telephone Network, and/or other networks or combination of networks, wired or wireless, as would be appreciated.

In some implementations of the invention, system 100 may process balance inquiries or EFTs via a user's mobile device (illustrated in FIG. 1 as mobile device 140). In some implementations of the invention, mobile device 140 may include, without limitation, a tablet computing device, a laptop computing device, a cellular phone, a Smartphone, a PDA, or other portable device that can transmit and receive financial account information such as account numbers.

In some implementations of the invention, a balance inquiry or EFT request is made from mobile device 140 to an EFT provider such as, without limitation, SHAZAM, NYCE, PULSE, STAR, INTERLINK, and/or other entity that provides EFTs. In other words, in some implementations of the invention, a user may determine a balance of a financial account via mobile device 140 without logging on to a website of or otherwise directly contacting a financial institution associated with the financial account. Likewise, in some implementations of the invention, a user may process an EFT via mobile device 140 without logging on to a website of or otherwise directly contacting the financial institution. In this manner, users may conveniently and in real-time obtain a balance of a financial account or request an EFT using a mobile device without having to find an ATM or directly contact a bank associated with the financial account.

In some implementations of the invention, mobile device 140 may be used to read or otherwise obtain account information such as an account identifier in order to request the balance inquiry or EFT. In some implementations of the invention, mobile device 140 may include or otherwise be removably coupled to a reader, described more fully below, which reads a medium that includes the account identifier. The medium may include, without limitation, a payment card, a smart chip, a Radio Frequency Identification (“RFID”) tag, other Near Field Communication (“NFC”) tag, or other medium that can communicate the account identifier. As such, the reader can include hardware and/or software that reads the medium to obtain the account identifier. For example, the reader can include, without limitation, a magnetic strip reader, a smart chip reader, an NFC reader, or other reader capable of reading the account identifier and accessible to mobile device 140.

In these implementations of the invention, via mobile device 140, a user may swipe a payment card or otherwise read a smart chip or an NFC tag in order to request the balance inquiry or EFT. For example, a user may wish to obtain a balance of a financial account before acquiring more chips at a casino gaming table. To obtain the balance, the user may swipe or otherwise read a payment card, chip, or NFC tag using mobile device 140 in order to request the balance inquiry. Likewise, the user may use mobile device 140 in order to request an EFT.

In some implementations of the invention, mobile device 140 may store, or otherwise retrieve from a memory (not illustrated in FIG. 1), the account identifier. In these implementations, a user may request, via mobile device 140, a balance inquiry or EFT based on the stored account identifier without logging on to a website of or otherwise directly contacting the financial institution associated with the financial account.

In some implementations of the invention, system 100 securely processes the balance inquiry or EFT using multi-factor authentication. For example, system 100 may obtain a first authentication by reading or otherwise obtaining an account identifier as described above. In some implementations of the invention, the identifier may include a credit card number, a debit card number, an account number, or other identifier that identifies the financial account.

In some implementations of the invention, system 100 may prompt the user for, via mobile device 140, entry of a phone number to be called in order to receive the authentication information via a channel different from the channel used to obtain the account identifier. In some implementations of the invention, the phone number may be stored in a memory of mobile device 140 such that upon presentation of the account identifier described above, mobile device 140 communicates the stored phone number to computing device 120. In some implementations of the invention, the phone number may include a phone number to a landline, Internet-based, cellular/mobile, or other telephone associated with the financial account.

Whichever implementation of obtaining the phone number is used, system 100 may obtain a second authentication via a separate channel such as by calling, via IVR 110, the phone number to prompt for and receive authentication information such as a PIN or other authentication. In this manner, even if the first communication channel is compromised (such as the communication channel used to communicate the account identifier), the second communication channel may be secure. In some implementations of the invention, the PIN is substantially immediately encrypted upon receipt for added security. Thus, using multi-factor authentication, system 100 may securely process balance inquiries and/or EFTs.

In some implementations of the invention, a balance inquiry or EFT may be processed via POS reader 130 in a manner similar to that described above with respect to mobile device 140. In some implementations of the invention, POS reader 130 may include, without limitation, a magnetic strip reader, an RFID reader or other NFC technology reader, an input device that accepts input of financial account information, or other device that can receive and transmit financial account information. In some implementations of the invention, POS reader 130 may be portable or fixed at a particular location. In some implementations, POS reader 130 may be configured to accept a phone number for multi-factor authentication. In some implementations of the invention, a casino gaming table or other location may be removably or fixedly equipped with POS reader 130.

Likewise, in some implementations of the invention, a balance inquiry or EFT may be processed via client device 160. In some implementations of the invention, client device 160 may include any computing device such as a desktop computer, laptop computer, or other device that can communicate with computing device 120 via network 102. For example, client device 160 may be used by a casino or other entity to request balance inquiries or EFTs. In some implementations, client device 160 may be configured to accept a phone number for multi-factor authentication. In some implementations, client device 160 may include or be removably coupled to a reader such as, without limitation, a magnetic strip reader, an RFID reader or other NFC technology reader, an input device that accepts input of financial account information, or other device that can receive and transmit financial account information.

In some implementations of the invention, any combination of mobile device 140, POS reader 130, or client device 160 may be used to swipe or otherwise read a magnetic strip, chip, tag, etc., receive a phone number or other secondary communication resource, or perform other functions. In these implementations, a particular function may be performed by one of these devices while another function is performed by another one of these devices. For example, a user may swipe a payment card at POS reader 130 and input a phone number using mobile device 140 or vice versa. Typically, although not necessarily, mobile devices 140 are each operated by their respective users while POS reader 130 or client device 160 is operated by a casino or other entity.

In some implementations of the invention, mobile device 140 may be directly coupled to computing device 120 via network 102 (such as when mobile device 140B is connected to computing device 120 via the Internet and/or wireless network of a casino). In these implementations, mobile device 140 may be used without a POS reader 130 in order to request a balance inquiry. In other words, in these implementations, mobile device 140 may be configured to receive input via a user interface of mobile device 140 and/or via a reader using a magnetic strip, chip, or RFID or other known NFC technology. As would be appreciated, the reader may be removably coupled to mobile device 140 or the reader may be integrated with mobile device 140.

In some implementations of the invention, mobile device 140 and/or client device 160 is directly coupled to POS reader 130 via a link (illustrated in FIG. 1 as link 142A, 142B). Link 142 may include a wired link such as a Universal Serial Bus (USB) link or a wireless link or protocol such as a BLUETOOTH connection, Radio Frequency Identification (RFID) link, or other near-field technology link. In these implementations, mobile device 140 may communicate account information and/or phone number to POS reader 130, which in turn communicates the information to computing device 120. In implementations pertaining to NFC technology, mobile device 140 may be equipped with an RFID tag or other NFC tag that is read by POS reader 130.

Thus, according to various implementations of the invention, system 100 may facilitate balance inquiries or EFTs via mobile device 140, POS reader 130, client device 160, or any combination of the foregoing. In other words, mobile device 140, POS reader 130, and client device 160 may each perform all functions of reading and communicating account information and/or phone numbers, or some functions may be performed by one while other functions are performed by another.

In this manner, a user may perform a balance inquiry, obtain a marker, acquire additional casino chips and/or cash using mobile device 140, POS reader 130, and/or client device 160. For example, while at a casino table, a user may process a balance inquiry and/or acquire additional chips (via funds transfer) using mobile device 140 without leaving the table.

According to various implementations of the invention, a balance inquiry includes a request to determine a balance of a financial account. The balance includes an actual amount of funds available rather than whether the amount of funds exceeds a particular purchase amount. For example, a balance inquiry may include determining an amount of funds available in an asset account and/or determining a credit available in a credit account. An asset account includes, without limitation, a checking account, a saving account, a money market account, a stock or bond account, or other account associated with assets. A credit account (i.e., debt account) can include, without limitation, a credit card account, a line of credit, or other account associated with credit or debt. According to various implementations of the invention, an EFT includes electronically transferring funds or money from one account to another. In some implementations of the invention, the EFT may be used to transfer funds as a basis for obtaining funds such as withdrawing cash and/or obtaining casino chips.

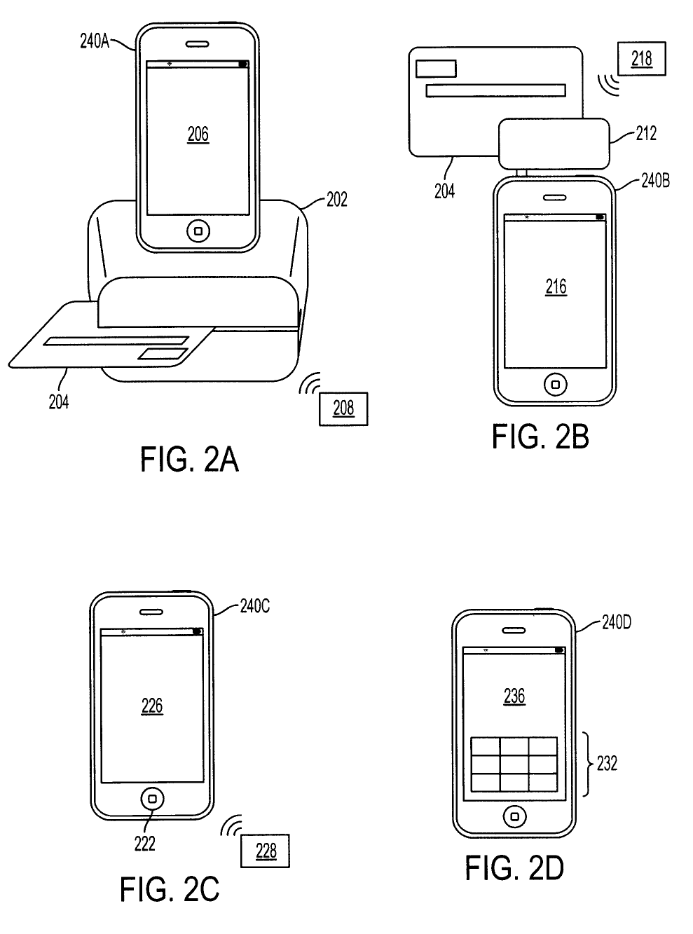

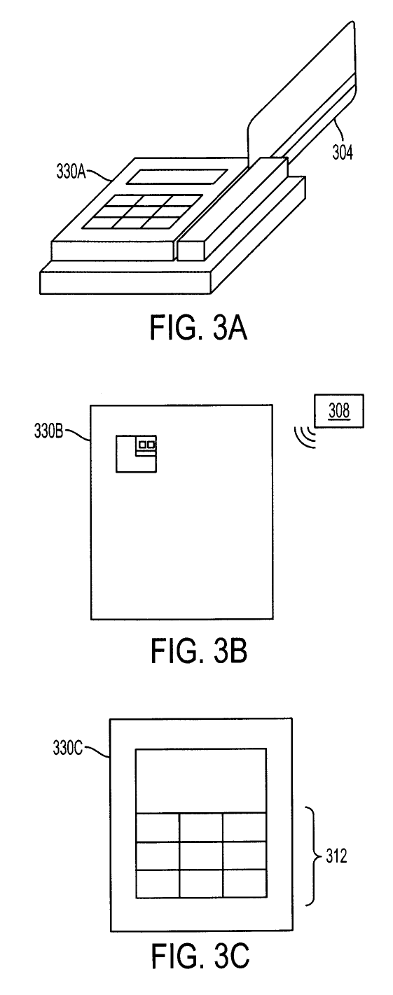

In some implementations of the invention, POS reader 130, mobile device 140, and/or client device 160 may communicate the account identifier to computing device 120 in order to request a balance inquiry. In other words, computing device 120 may receive an account identifier in order to process a balance inquiry. In some implementations of the invention, computing device 120 may receive an account identifier via at least one of: POS reader 130, mobile device 140, and/or client device 160. For example, computing device 120 may receive the identifier and phone number via various devices and/or protocols such as those illustrated in FIGS. 2 and 3. In some implementations of the invention, using mobile device 140, POS reader 130, and/or client device 160, a user may swipe a payment card (such as, without limitation, a credit card or a debit card), input information via a keypad (including soft keys and/or hard keys), present a mobile device or other device having NFC technology, and/or perform other actions that cause the identifier and phone number to be communicated.

In some implementations of the invention, computing device 120 may initiate a communication via the phone number. In some implementations of the invention, computing device 120 may receive an authentication via the communication, wherein the authentication authorizes access to the financial account. For example, the authentication may include a PIN associated with a payment, a predefined authentication such as a password, or other information that authenticates a user or otherwise authorizes access to a financial account.

In some implementations of the invention, the communication may be initiated to mobile device 140 or other device associated with the account holder. In some implementations of the invention, the communication may include a telephone call to the phone number via IVR 110. In these implementations, IVR 110 may prompt for and receive the authentication using, without limitation, touch tone input, voice input, or other input that known IVR systems may process. In some implementations of the invention, the communication may include a Short Message Service (“SMS”) text message (or other form of text messages as would be appreciated) to the phone number, a response to which may provide the authentication.

Although described in various examples as a phone call to a phone number, channels separate from a phone call may be used. For example, instead of a phone call, other communication channels such as email, SMS text, or other communication channel may be used to receive the authentication. In these implementations, an email address or other contact information may be received by computing device 120 to be used to initiate the communication. In this manner, computing device 120 may securely access the financial account based on authentication information received from a communication channel separate from the channel in which the account identifier is received. In other words, in some implementations of the invention, a second communication channel (e.g., phone call, SMS text, email, etc.) separate from the first communication channel (from which the account identifier is obtained) may be used to receive the authentication to access a financial account for balance inquiry and/or EFT processing. In this manner, system 100 may achieve secure multi-factor authentication for balance inquiries and/or EFTs.

In some implementations of the invention, computing device 120 may process a balance inquiry of the financial account based on the identifier and the authentication information. For example, computing device 120 may generate a balance inquiry request based on a credit card number or other account identifier and the authentication information. In these implementations, the balance inquiry request may require the authentication information such as a PIN. In some implementations of the invention, the balance inquiry is requested from an EFT provider.

In some implementations of the invention, computing device 120 may determine a balance of the financial account based on the balance inquiry. For example, in response to the balance inquiry, computing device 120 may request and receive a current balance of the financial account associated with the identifier. Unlike a determination of whether a financial account has sufficient funds or credit to cover a particular purchase or withdrawal amount, the balance inquiry provides an actual balance (i.e. total funds available for an asset account or a current total available credit for a credit account). Thus, according to various implementations of the invention, the balance may indicate a total purchasing power associated with the financial account. In this manner, credit or withdrawal amount decisions may be based on the balance.

In some implementations of the invention, computing device 120 may receive an account type for the financial account. In these implementations, the balance inquiry may be based on the account type. In some implementations of the invention, the account type may be received in a manner similar to the identifier as described above. For example, in some implementations, a user may input the account type using POS reader 130, mobile device 140, or client device 160. In some implementations, the account type may be stored using mobile device 140, into a payment card, or other device used to identify a financial account so that the account type does not need to be input.

In some implementations of the invention, the account type may include a credit/debt account. In these implementations, the balance inquiry may include a credit available for the credit/debt account.

In some implementations of the invention, the account type may include an asset account. In these implementations, the balance inquiry may include a balance (i.e., available funds or assets) of the asset account.

In some implementations of the invention, computing device 120 may process a balance inquiry via a network of member financial institutions. In these implementations, the member financial institutions may have agreed to provide balance inquiry services through an EFT provider. In some implementations of the invention, EFT provider computer 150 may expose a webservice or other data service that processes balance inquiries or EFTs for one or more member financial institutions based on account identifiers. In these implementations, computing device 120 may request balance inquiries from EFT provider computer 150. In some implementations, EFT provider computer 150 requires authentication in order to accept balance inquiry requests. These implementations are typically, but not necessarily, associated with financial accounts having PIN or other authentications to authenticate access to the financial account. In other implementations, authentication may not be required to process balance inquiries. These implementations are typically, but not necessarily, associated with financial accounts that do not require PINs.

In some implementations of the invention, computing device 120 may be used to perform balance inquiries without multi-factor authentication (“PIN-free balance inquiries”). Various processing and functions described above with respect to multi-factor authentication of balance inquiries are applicable to PIN-free balance inquiries, with differences noted below. Unlike multi-factor authentication of balance inquiries, these implementations do not prompt for PIN or other authentication in order to process the balance inquiries. In some implementations of PIN-free balance inquiries, computing device 120 may receive an identifier of a financial account. In some implementations of PIN-free balance inquiries, computing device 120 may communicate to an EFT provider a balance inquiry of the financial account based on the identifier. The EFT provider may include various EFT providers described above with respect to multi-factor authentication of balance inquiries. In some implementations of PIN-free balance inquiries, computing device 120 may determine a balance of the financial account based on the balance inquiry.

In some implementations of the invention, POS reader 130, mobile device 140, and/or client device 160 may communicate the account identifier to computing device 120 in order to request an EFT. In other words, computing device 120 may receive an account identifier in order to process an EFT. Various processing and functions described above with respect to multi-factor authentication of balance inquiries are applicable to multi-factor processing of EFTs, with differences noted below. In some implementations of the invention, computing device 120 may be used to efficiently and in real-time process EFTs from financial accounts. In other words, computing device 120 may be used to withdraw cash, and/or purchase casino chips or other items/credits using funds or available credit associated with the financial account. For example, a user such as a gambler may obtain credit, chips, or money at a gaming table via a user's mobile device or via a casino device, either of which is coupled to or is otherwise part of system 100.

In some implementations of the invention, computing device 120 may receive an identifier of a financial account and a phone number associated with the financial account. In some implementations of the invention, computing device 120 may initiate a communication via the phone number. In some implementations of the invention, computing device 120 may receive an indication of an amount of funds to be transferred. For example, the amount of funds to be transferred may include a dollar amount that a gambler wishes to obtain in casino chips by transferring funds from the gambler's financial account to a casino account. In some implementations of the invention, computing device 120 may receive an authentication via the communication. In some implementations of the invention, the authentication authorizes access to the financial account such as by including a PIN or other authentication associated with the financial account.

In some implementations of the invention, computing device 120 may communicate an EFT request associated with the financial account based on the identifier, the authentication, and the amount of funds to be transferred. In some implementations of the invention, the EFT request may include, without limitation, an ISO 8583 payment message supported by various EFT networks. As would be appreciated, each network may adapt the ISO 8583 standard for its own use with custom fields and custom usages. As would be further appreciated, the placement of fields in different versions (such as 1987, 1993 and 2003) of the standard varies. In some implementations, one EFT network may act as a gateway to other EFT networks to provide universal coverage.

In some implementations of the invention, computing device 120 may cause the amount of funds to be transferred based on the EFT request. In some implementations of the invention, the EFT is processed by or otherwise fulfilled by an EFT provider (such as by EFT provider computer 150).

In some implementations of the invention, computing device 120 may determine a monetary value (i.e., amount) to extend based on the EFT request. In some implementations of the invention, the monetary value to extend may comprise a marker amount at a casino. In some implementations of the invention, the marker amount, if approved, may be redeemed as casino chips, casino credit, or cash. In some implementations of the invention, the marker amount may be stored in mobile device 140 as a credit. For example, mobile device 140 with the stored credit may be used to obtain funds or make purchases at tables, retailers, or other locations associated with a casino that granted the marker.

In some implementations of the invention, the monetary value to extend may comprise a number of casino chips to extend at a gaming table. In these implementations, for example, a user may request a balance inquiry and obtain a balance of a financial account at the gaming table (or other location via mobile device 140 or POS reader 130).

In some implementations of the invention, the monetary value to extend may comprise an amount available for purchases at a retailer associated with a casino. In these implementations, the balance may be used to determine an amount of casino credit that can be used to make purchases at retailers associated with the casino. Retailers associated with the casino may include, without limitation, retailers located within the casino or retailers having agreements with the casino to accept casino credit. In some implementations of the invention, the casino credit may be used to redeem chips and/or make purchases at participating retailers.

In some implementations of the invention, the monetary value to extend may comprise an amount of cash to dispense at an Automated ATM. In these implementations, the ATM may be configured to accept the phone number or other resource identifier and initiate, via computing device 120, the communication in order to perform multi-factor authentication using the ATM and another communication channel.

According to various implementations of the invention, computing device 120 may include a processor 122, a memory 124, and/or other components that facilitate the functions of computing device 120 described herein. In some implementations of the invention, processor 122 includes one or more processors configured to perform various functions of promotional computing device 120. In some implementations of the invention, memory 124 includes one or more tangible (i.e., non-transitory) computer readable media. Memory 124 may include one or more instructions that when executed configure processor 122 to perform the functions of computing device 120. In some implementations of the invention, memory 124 may include instructions that when executed on POS reader 130 or mobile device 140 cause one or both of these devices to accept account identifier, phone number, email address and/or other information disclosed herein. For example, memory 124 may include instructions (i.e., a mobile application) that may be downloaded by mobile device 140. The mobile application when executed may cause mobile device 140 to communicate with computing device 120 in order to perform various functions described herein. Similarly, instructions may be downloaded by POS reader 130 in order to likewise configure POS reader 130 to communicate with computing device 120.

In some implementations of the invention, upon completion of a transaction, a receipt may be communicated to the customer/account holder. In some implementations, the receipt may be communicated via SMS text or electronic mail. In some implementations, the receipt may include various transaction data such as, without limitation, a name of the casino/merchant where the transaction was processed, a location/address of the casino/merchant, an account identifier such as a card number, a terminal number where the transaction was processed, a date, a time, a sequence number or other transaction identifier, a type of transaction (such as “purchase”), a monetary amount of the transaction, and a ledger balance associated with the account, and an available balance associated with the account.

In some implementations of the invention, POS reader 130, ATM, or mobile device 140 may store a history of transactions. The history may include, without limitation, a phone number, an account identifier such as a card number, a date, a time, a sequence number, a type of transaction (such as “purchase”), a monetary amount of the transaction, and a response indicator (such as “text response”). In this manner, a merchant or other operators of these devices may have a log of transactions in the event that a particular transaction is questioned.

Although some examples described above relate to casino markers, credits, or cash withdrawals, these examples are for illustration purposes and not limitation. For example, processing balance inquiries or EFTs described herein may be applied in other contexts in which obtaining a balance of a financial account or processing EFTs may be desirable.

FIGS. 2A, 2B, 2C, and 2D are block diagrams illustrating exemplary mobile devices 240, according to various implementations of the invention. According to various implementations of the invention, as illustrated in FIG. 2A, mobile device 240A may be coupled to a cradle style reader 202. In some implementations of the invention, cradle style reader 202 may include a magnetic strip reader (not illustrated) that is used to swipe a payment card 204. In some implementations of the invention, cradle style reader 202 may include a chip reader, NFC reader, or other reader that can read a smart chip, NFC tag, or other medium 208. In some implementations of the invention, medium 208 can include active or passive tags that can be read when placed on or near cradle style reader 202.

According to various implementations of the invention, as illustrated in FIG. 2B, mobile device 240B may be coupled to an attachment reader 212. In some implementations of the invention, attachment reader 212 may include a magnetic strip reader (not illustrated) that is used to swipe a payment card 214. In some implementations of the invention, attachment reader 212 may include a chip reader, NFC reader, or other reader that can read a smart chip, NFC tag, or other medium 218. In some implementations of the invention, medium 218 can include active or passive tags that can be read when placed on or near attachment reader 212.

According to various implementations of the invention, as illustrated in FIG. 2C, mobile device 240C may include an integrated reader 222. In some implementations of the invention, integrated reader 222 may include a chip reader, NFC reader, or other reader that can read a smart chip, NFC tag, or other medium 228. In some implementations of the invention, medium 228 can include active or passive tags that can be read when placed on or near integrated reader 222.

According to various implementations of the invention, as illustrated in FIG. 2D, mobile device 240D may include a user interface 236 that provides input members 232. In some implementations of the invention, input members may be used to input account information such as an account identifier and/or phone number or other secondary communication identifier.

Referring to FIG. 2 generally, mobile devices 240 may each include a user interface (illustrated in FIGS. 2A-2D as interfaces 206, 216, 226, and 236). A user or other entity may download various instructions such as a mobile application to mobile devices 240. The instructions when executed by a processor (not illustrated in FIGS. 2A-2D) of mobile device 240 causes the processor to generate interfaces 206, 216, 226, and 236, which may be configured to receive account information from payment cards, chips, tags, input member input, etc., and/or prompt for a phone number or other contact method that uses a secondary communication channel. In some implementations of the invention, the mobile application may facilitate communication between mobile device 240 and computing device 120, thereby allowing mobile device 240 to be used to request a balance inquiry or an EFT.

In some implementations of the invention, the mobile application may be configured such that different casinos or other locations may be processed by the mobile application. In other words, the mobile application may cause EFTs to be transferred to particular accounts of casinos or others. For example, the mobile application may include settings that can be used to enter names of casinos and their account identifiers. In another example, the mobile application may be preconfigured to recognize various different casinos and their account identifiers. The particular casino or other location in which the mobile device is currently located may be input by the user and/or detected automatically based on geo-location or other location-based service. In other implementations, the mobile application may be specifically tailored for a particular casino or other location (i.e., a casino may have its own downloadable mobile application configured to interact with computing device 120). In some implementations of the invention, the mobile application is compatible with and receives input from cradle style reader 202, attachment reader 212, integrated reader 222, and input members 232.

In some implementations of the invention, computing device 120 may cause the mobile application to be downloaded to mobile device 240. For example, the instructions associated with the mobile application may be stored within memory 124 or other accessible memory location of computing device 120.

FIGS. 3A, 3B, and 3C are block diagrams illustrating exemplary POS readers 330 (illustrated in FIGS. 3A, 3B, and 3C as POS readers 330A, 330B, and 330C), according to various implementations of the invention. According to various implementations of the invention, as illustrated in FIG. 3A, POS reader 330A may include a magnetic strip reader that reads a swiped payment card 304. According to various implementations of the invention, as illustrated in FIG. 3B, POS reader 330B may include a chip reader, RFID reader, NFC tag reader, or other reader that can read a chip, RFID tag, NFC tag, or other medium 308 that communicates account information and/or phone numbers when placed on or near POS reader 330B. Such medium 308 may be embedded within or otherwise coupled to a payment card, mobile device 140, or other structure that houses medium 308. According to various implementations of the invention, as illustrated in FIG. 3C, POS reader 330C may include input members 312 that may be used to input the account number and/or phone number. In some implementations of the invention, POS reader 330 may be configured as a portable reader, a fixed reader, an ATM kiosk, and/or other reading device.

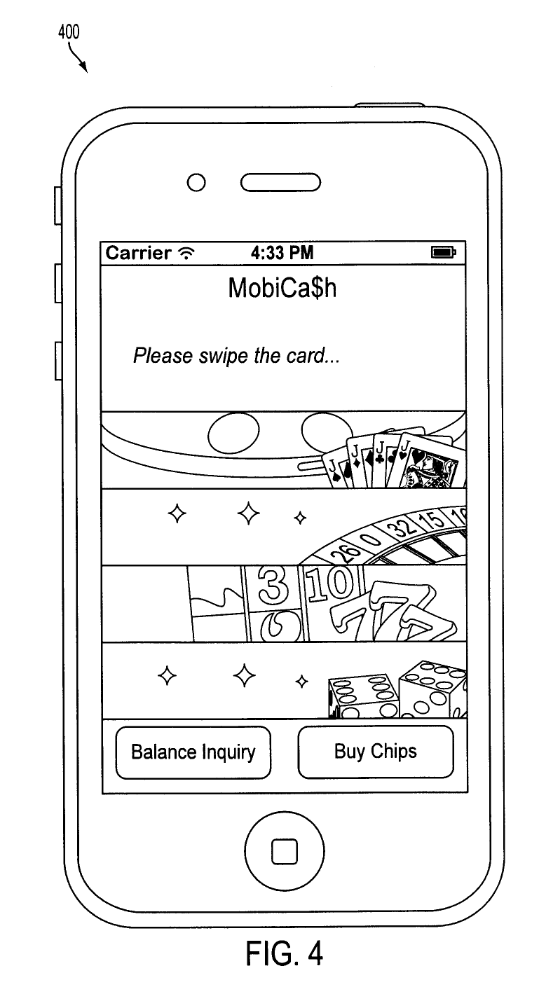

FIGS. 4, 5, 6, 7, 8, and 9 are screenshots illustrating exemplary interfaces of a mobile application operating at mobile device during different processing operations, according to various implementations of the invention. As would be appreciated, the various displays and processes illustrated in FIGS. 4-9 may be implemented using mobile device 140, POS reader 130, and/or client device 160. The various processing operations and/or data flows depicted by FIGS. 4-9 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In some implementations of the invention, one or more of the operations may be performed simultaneously. Accordingly, the operations as illustrated (and described in greater detail below) are examples by nature and, as such, should not be viewed as limiting.

According to various implementations of the invention, as illustrated by screenshot 400 of FIG. 4, a mobile application or other process may request a card swipe, smart chip read, NFC read, or other input of account information. In some implementations of the invention, music or other audio (and/or graphics for display) may be communicated to the mobile device while the transaction is initiated, processed and/or completed.

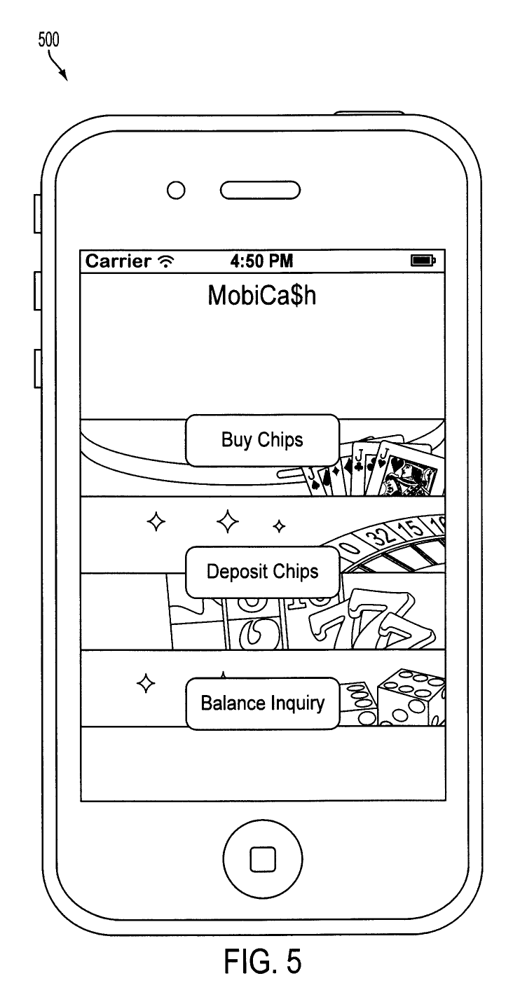

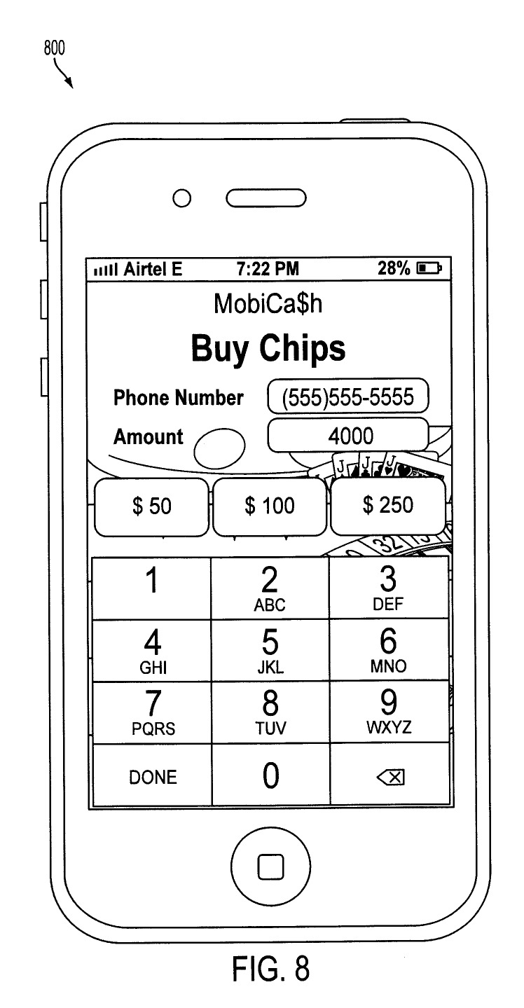

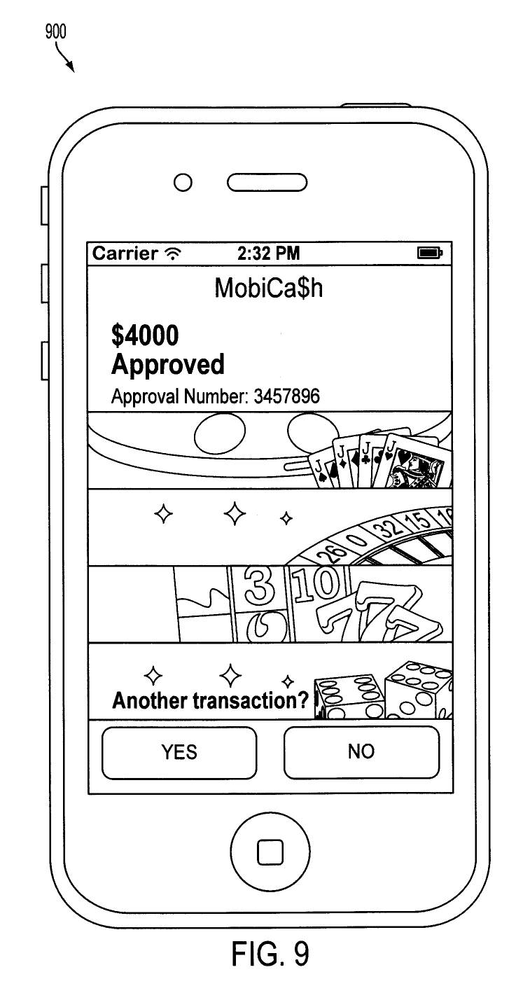

According to various implementations of the invention, as illustrated by screenshot 500 of FIG. 5, the mobile application or other process may prompt the user to select to either request a balance inquiry, request an EFT in order to, for example, buy chips from a casino, or request a deposit such as depositing chips. As previously noted, the mobile application may be configured to recognize an account of the casino in order to facilitate the EFT. In some implementations of the invention, requesting a chip deposit occurs in a manner similar to the screenshots of FIGS. 8 and 9 that illustrate buying chips. In some implementations, for example, a gambler at a casino table may select the deposit chips button in order to deposit an amount of funds equivalent to a face value of casino chips into a financial account. In these implementations, the gambler may surrender the chips in order to deposit funds associated with the face value of the chips into the financial account. In this manner, the gambler may cash in chips into the financial account associated with a card swipe or other input method described herein.

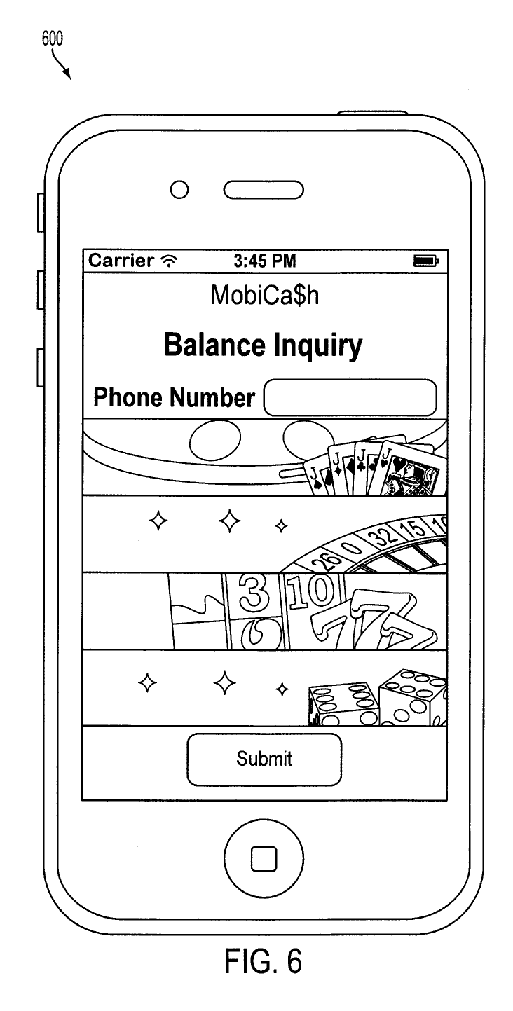

According to various implementations of the invention, as illustrated by screenshot 600 of FIG. 6, upon selection of a request for a balance inquiry, the mobile application or other process may prompt the user to input a phone number or other secondary communication channel. Upon input of the phone number, the mobile application may cause the phone number to be called in order to perform multi-factor authentication. For example, the mobile application may communicate the phone number to computing device 120, which may initiate the phone call. Upon receiving authentication information via the phone call (such as through IVR 110), the balance inquiry may be processed based on the account information received from the card swipe or other account information input.

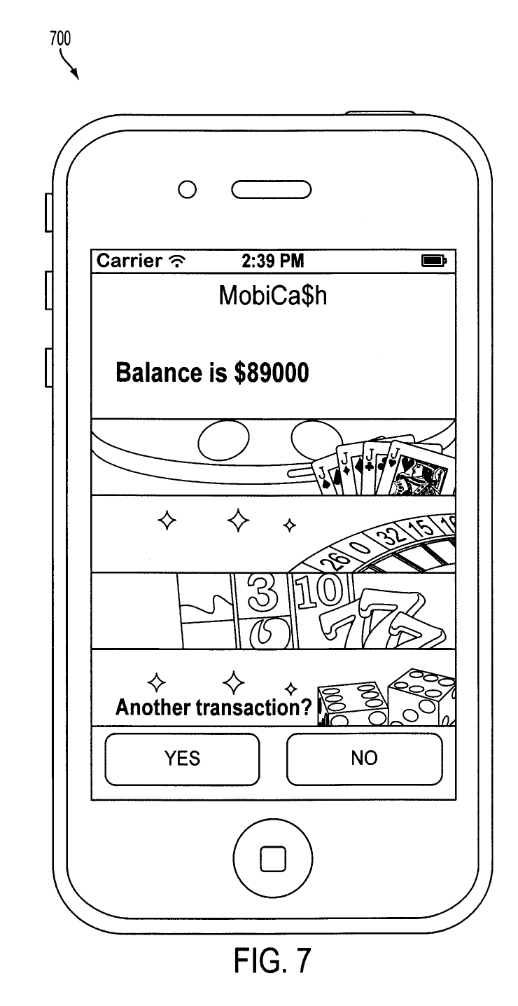

According to various implementations of the invention, as illustrated by screenshot 700 of FIG. 7, the mobile application or other process may receive and display the balance. In some implementations of the invention, the mobile application may prompt the user to input whether another transaction is desired. If another transaction is not desired, the mobile application or other process may cause a return to a state illustrated in FIG. 4. If another transaction is desired, the mobile application or other process may cause a return to a state illustrated in FIG. 5, where the user may select to request a balance inquiry or an EFT.

According to various implementations of the invention, as illustrated by screenshot 800 of FIG. 8, upon receiving a request for an EFT, the mobile application or other process may prompt input of an amount of the EFT request and a phone number or other secondary communication channel. In some implementations of the invention, the amount may be input via a numeric touch pad displayed by the mobile application and/or via predefined buttons corresponding to particular amounts. In some implementations, selection of the “x” button causes the numeric touch pad to disappear, revealing predefined buttons. Upon input of the phone number, the mobile application may cause the phone number to be called in order to perform multi-factor authentication. Furthermore, the mobile application may communicate the EFT request to computing device 120, where the EFT request is processed. In some implementations of the invention, computing device 120 causes the EFT request to be submitted to EFT provider computer 150 illustrated in FIG. 1.

According to various implementations of the invention, as illustrated by screenshot 900 of FIG. 9, upon receiving an indication (from computing device 120, for example) that the EFT request was processed and approved, the mobile application or other process may indicate the approval and a confirmation or approval number. In some implementations of the invention, the mobile application may prompt the user whether another transaction is desired as before. In some implementations of the invention (not illustrated in the Figures), upon receiving an indication the EFT request was declined, a reason for the declined request may be provided as well as a prompt to request whether another transaction is desired.

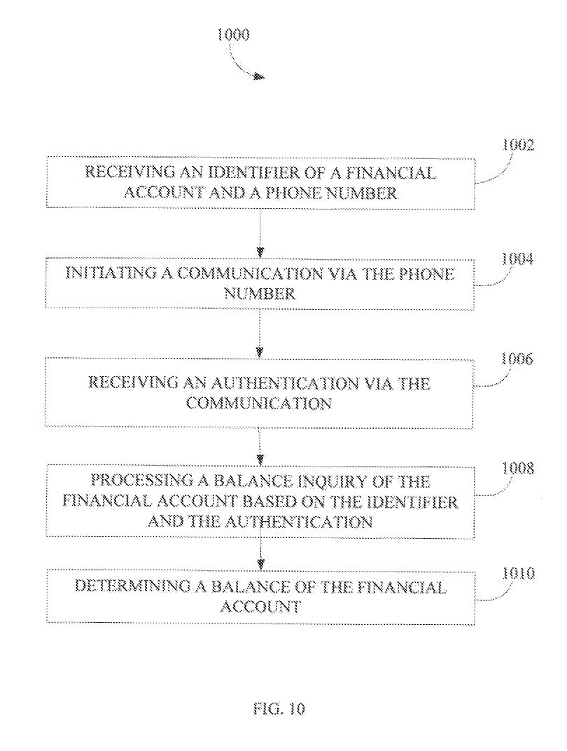

FIG. 10 is a flow diagram illustrating an exemplary of a process 1000 of processing balance inquiries, according to various implementations of the invention. In an operation 1002, process 1000 may include receiving an identifier of a financial account and a phone number associated with the financial account. In an operation 1004, process 1000 may include initiating a communication via the phone number. In an operation 1006, process 1000 may include receiving an authentication via the communication, wherein the authentication authorizes access to the financial account. In an operation 1008, process 1000 may include processing a balance inquiry of the financial account based on the identifier and the authentication. In an operation 1010, process 1000 may include determining a balance of the financial account based on the balance inquiry.

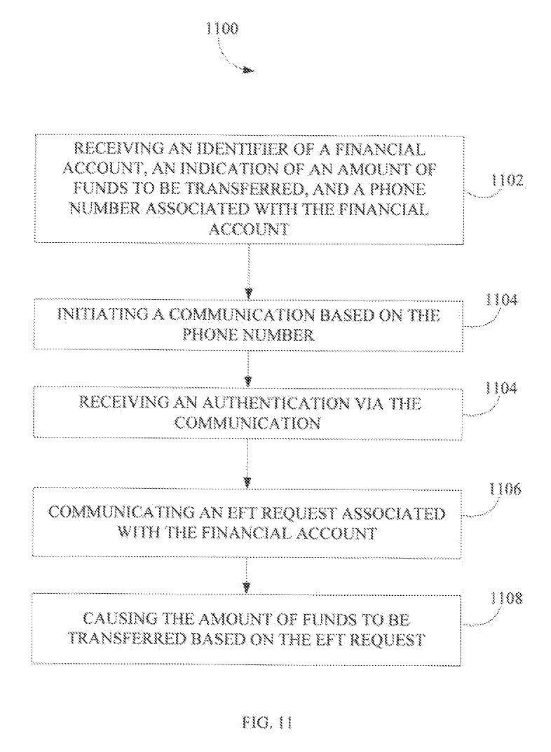

FIG. 11 is a flow illustrating an exemplary of a process 1100 of processing electronic funds transfers, according to various implementations of the invention. In an operation 1102, process 1100 may include receiving an identifier of a financial account, an indication of an amount of funds to be transferred, and a phone number associated with the financial account. In an operation 1104, process 1100 may include initiating a communication based on the phone number. In an operation 1106, process 1100 may include receiving an authentication via the communication, wherein the authentication authorizes access to the financial account. In an operation 1108, process 100 may include communicating an EFT request associated with the financial account based on the identifier, the authentication, and the amount of funds to be transferred. In an operation 1110, process 1100 may include causing the amount of funds to be transferred based on the EFT request.

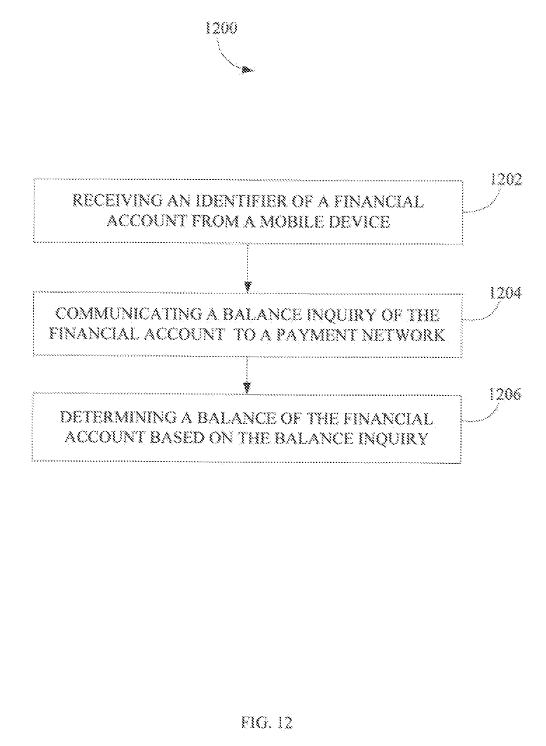

FIG. 12 is a flow diagram illustrating an exemplary of a process 1200 of processing balance inquiries from EFT providers using mobile devices, according to various implementations of the invention. In an operation 1102, process 1100 may include receiving an identifier of a financial account. In an operation 1104, process 1100 may include communicating to a payment network a balance inquiry of the financial account based on the identifier. In an operation 1106, process 1100 may include determining a balance of the financial account based on the balance inquiry.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of processing balance inquiries of financial accounts, comprising:
receiving, by a computing device, an identifier of a financial account and contact information associated with the financial account;
initiating, by the computing device, a communication via the contact information;
receiving, by the computing device, an authentication via the communication, wherein the authentication authorizes access to the financial account;
processing, by the computing device, a balance inquiry of the financial account based on the identifier and the authentication; and
determining, by the computing device, a balance of the financial account based on the balance inquiry.

2. The method of claim 1, further comprising:
receiving, by the computing device, an account type for the financial account, wherein the balance inquiry is based on the account type.

3. The method of claim 2, wherein the account type comprises a credit/debt account, and wherein the balance inquiry comprises a credit available of the credit/debt account.

4. The method of claim 2, wherein the account type comprises an asset account, and wherein the balance inquiry comprises a balance of the asset account.

5. The method of claim 1, wherein processing a balance inquiry further comprises processing a balance inquiry via an electronic funds transfer (EFT) provider.

6. The method of claim 1, wherein receiving an identifier comprises receiving the account identifier via at least one of: a reader device communicably coupled to the computing device, a mobile device communicably coupled to the computing device, or a client device communicably coupled to the computing device.

7. The method of claim 1, wherein receiving contact information comprises receiving one or more of a phone number or an email address, and wherein initiating a communication comprises one or more of initiating a call to the phone number, initiating a text message to the phone number, or initiating an email to the email address.

8. The method of claim 1, wherein receiving an identifier of a financial account and contact information comprises:
receiving the identifier via a first communication channel; and
receiving the contact information via a second communication channel separate from the first communication channel.

9. The method of claim 1, further comprising:
receiving, by the computing device, an indication of an amount of funds to be transferred from the financial account;
communicating, by the computing device, an Electronic Funds Transfer (EFT) request associated with the financial account based on the identifier, the authentication, and the amount of funds to be transferred; and
causing, by the computing device, the amount of funds to be transferred based on the EFT request.

10. A method of processing electronic funds transfers (EFTs), comprising:
receiving, by a computing device, an identifier of a financial account, an indication of an amount of funds to be transferred, and contact information associated with the financial account;
initiating, by the computing device, a communication based on the contact information;
receiving, by the computing device, an authentication via the communication, wherein the authentication authorizes access to the financial account;
communicating, by the computing device, an EFT request associated with the financial account based on the identifier, the authentication, and the amount of funds to be transferred; and
causing, by the computing device, the amount of funds to be transferred based on the EFT request.

11. The method of claim 10, further comprising:
determining, by the computing device, a monetary value to extend based on the balance.

12. The method of claim 11, wherein determining a monetary value to extend comprises determining a marker amount at a casino.

13. The method of claim 11, wherein determining a monetary value to extend comprises determining a number of casino chips to extend at a gaming table.

14. The method of claim 11, wherein determining a monetary value to extend comprises determining an amount available for purchases at a retailer associated with a casino.

15. The method of claim 11, wherein determining a monetary value to extend comprises determining an amount of cash to dispense at an Automated Teller Machine.

16. The method of claim 10, wherein receiving contact information comprises receiving one or more of a phone number or an email address, and wherein initiating a communication comprises one or more of initiating a call to the phone number, initiating a text message to the phone number, or initiating an email to the email address.

17. The method of claim 10, wherein receiving an identifier of a financial account and contact information comprises:
receiving the identifier via a first communication channel; and
receiving the contact information via a second communication channel separate from the first communication channel.

18. A system of processing balance inquiries of financial accounts, comprising:
a computing device comprising one or more processors configured to:
receive an identifier of a financial account and contact information associated with the financial account;
initiate a communication via the contact information;
receive an authentication via the communication, wherein the authentication authorizes access to the financial account;
process a balance inquiry of the financial account based on the identifier and the authentication; and
determine a balance of the financial account based on the balance inquiry.

19. The system of claim 18, the computing device further configured to:
receive an account type for the financial account, wherein the balance inquiry is based on the account type.

20. The system of claim 19, wherein the account type comprises a credit/debt account, and wherein the balance inquiry comprises a credit available of the credit/debt account.

21. The system of claim 19, wherein the account type comprises an asset account, and wherein the balance inquiry comprises a balance of the asset account.

22. The system of claim 18, wherein the computing device is further configured to:
process the balance inquiry via an electronic funds transfer (EFT) provider.

23. The system of claim 18, wherein the computing device receives the account identifier via at least one of: a reader device communicably coupled to the computing device, a mobile device communicably coupled to the computing device, or a client device communicably coupled to the computing device.

24. The system of claim 18, wherein the contact information comprises one or more of a phone number or an email address, and wherein the communication is initiated via one or more of: a call to the phone number, a text message to the phone number, or an email to the email address.

25. The system of claim 18, wherein the identifier of a financial account is received via a first communication channel and the contact information is received via a second communication channel separate from the first communication channel.

26. A system of processing electronic funds transfers (EFTs), comprising:
a computing device comprising one or more processors configured to:
receive an identifier of a financial account, an indication of an amount of funds to be transferred, and contact information associated with the financial account;
initiate a communication based on the contact information;
receive an authentication via the communication, wherein the authentication authorizes access to the financial account;
communicate an EFT request associated with the financial account based on the identifier, the authentication, and the amount of funds to be transferred; and
cause the amount of funds to be transferred based on the EFT request.
